(19) United States
(12) Patent Application Publication
(10) Pub. No.: US 2017/0134238 A1
(43) Pub. Date: May 11, 2017

(54) PHYSICAL MACHINE MANAGEMENT DEVICE AND PHYSICAL MACHINE MANAGEMENT METHOD

(71) Applicant: Institute For Information Industry, Taipei (TW)

(72) Inventors: Hsin Tse LU, Taipei City (TW); Shih Yu LU, Puli Township (TW)

(21) Appl. No.: 15/015,123

(22) Filed: Feb. 4, 2016

(30) Foreign Application Priority Data
Nov. 5, 2015 (TW) 104136477

(51) Int. Cl. H04L 12/24

(52) U.S. Cl. CPC H04L 41/12; H04L 41/22; H04L 41/16; H04L 41/0213

(57) ABSTRACT

A physical machine management device and a physical machine management method are provided. The physical machine management device includes a monitoring unit and a deployment unit which is electrically connected with the monitoring unit. The monitoring unit is configured to monitor information of a hardware pool. The hardware pool includes a first group and a second group which are of different types. The first group includes a physical machine. The deployment unit is configured to move the physical machine from the first group to the second group according to a deployment blueprint and the information. The physical machine management method includes the steps corresponding to the operations of the physical machine management device.

### PRIORITY

This application claims priority to Taiwan Patent Application No. 104136477 filed on Nov. 5, 2015, which is incorporated herein for reference in its entirety.

### FIELD

The present invention relates to a management device and a management method. More particularly, the present invention relates to a physical machine management device and a physical machine management method.

### BACKGROUND

With the advancement of the computer technology, physical machines providing different services can be deployed to meet various demands of human or solve various problems. Generally, managers of the physical machines first decide what service is to be provided by each of the physical machines (i.e., what role is to be played by each of the physical machines), and then deploy each of the physical machines by installing a corresponding operation system and/or designating a corresponding operation mode. Once being deployed, each of the physical machines is capable of providing the corresponding service (i.e., is capable of performing the corresponding work). For example, if the network function needs to be provided by a physical machine, then the manager may deploy the physical machine as a network node. As another example, if the computing function needs to be provided by a physical machine, then the manager may deploy the physical machine as a computing node. As yet another example, if the storage function needs to be provided by a physical machine, then the manager may deploy the physical machine as a storage node.

In practice, after a physical machine is deployed, the service that the physical machine can provide becomes invariable and other services cannot be provided (i.e., it cannot play other roles any longer) by the physical machine. Thus, if the number of physical machines providing a certain service is insufficient, then the conventional way is to additionally provide (i.e., add) a physical machine and then deploy the additional physical machine as a physical machine that is capable of providing the same service. For example, if the number of physical machines providing the computing service is insufficient, then the conventional way is to additionally provide a physical machine and then deploy the physical machine as a computing node. It can be known from the above descriptions that, the conventional way at least has the drawbacks of causing the additional cost of additionally providing the physical machine and increasing the time of deploying the physical machine.

Accordingly, an urgent need exists in the art to provide a more effective solution under the circumstance that the number of physical machines providing a certain service is insufficient.

### SUMMARY

The disclosure includes a physical machine management device. The physical machine management device may comprise a monitoring unit and a deployment unit electrically connected to the monitoring unit. The monitoring unit may be configured to monitor information of a hardware pool. The hardware pool may include a first group and a second group which are of different types. The first group may include a physical machine. The deployment unit may be configured to move the physical machine from the first group to the second group according to a deployment blueprint and the information.

The disclosure also includes a physical machine management method. The physical machine management method comprises the following steps of: monitoring information of a hardware pool by a monitoring unit, the hardware pool including a first group and a second group which are of different types, and the first group including a physical machine; and moving, by a deployment unit, the physical machine from the first group to the second group according to a deployment blueprint and the information.

In certain embodiments the present invention can obtain various pieces of information of all physical machines by monitoring all the physical machines, and knows therefrom the status of all the physical machines (e.g., the available resources and the operation efficiency, etc.). Additionally, the present invention can change to which group the physical machine belongs (i.e., change the service that the physical machine previously provides) according to a deployment blueprint and the information. Therefore, under the circumstance that the number of physical machines providing a certain service is insufficient, the present invention may additionally determine whether one or more physical machines not providing the service have the capability to provide the service instead. If the determination result is “Yes”, then the present invention may further change the one or more physical machines not providing the service into physical machines providing the service. As compared to the conventional processing method, the present invention can effectively reduce the possibility of additionally providing physical machines and correspondingly reduce the time of deploying these physical machines.

What described above presents a summary of some aspects of the present invention (including the problem to be solved, the means to solve the problem and the effect of the present invention) to provide a basic understanding of these aspects. However, this is not intended to contemplate all aspects of the present invention. Additionally, what described above is neither intended to identify key or essential elements of any or all aspects of the present invention, nor intended to describe the scope of any or all aspects of the present invention. This summary is provided only to present some concepts of some aspects of the present invention in a simple form and as an introduction to the following detailed description.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a block diagram illustrating an exemplary example of a physical machine management device according to one or more embodiments of the present invention;

FIG. 2 is a schematic view illustrating an exemplary example of how the current work of a physical machine migrate according to one or more embodiments of the present invention;

FIG. 3 is a schematic view illustrating an exemplary example of the overall operation of a physical machine management device according to one or more embodiments of the present invention; and

FIG. 4 is a flowchart diagram illustrating an exemplary example of a physical machine management method according to one or more embodiments of the present invention.

### DETAILED DESCRIPTION

In the following description, the present invention will be explained with reference to example embodiments thereof. However, these example embodiments are not intended to limit the present invention to any specific examples, embodiments, environment, applications, structures, processes or steps described in these example embodiments. In the attached drawings, elements unrelated to the present invention are omitted from depiction. In addition, the dimensional relationships among individual elements in the attached drawings are illustrated only for ease of describing the present invention, but not to limit the actual scale.

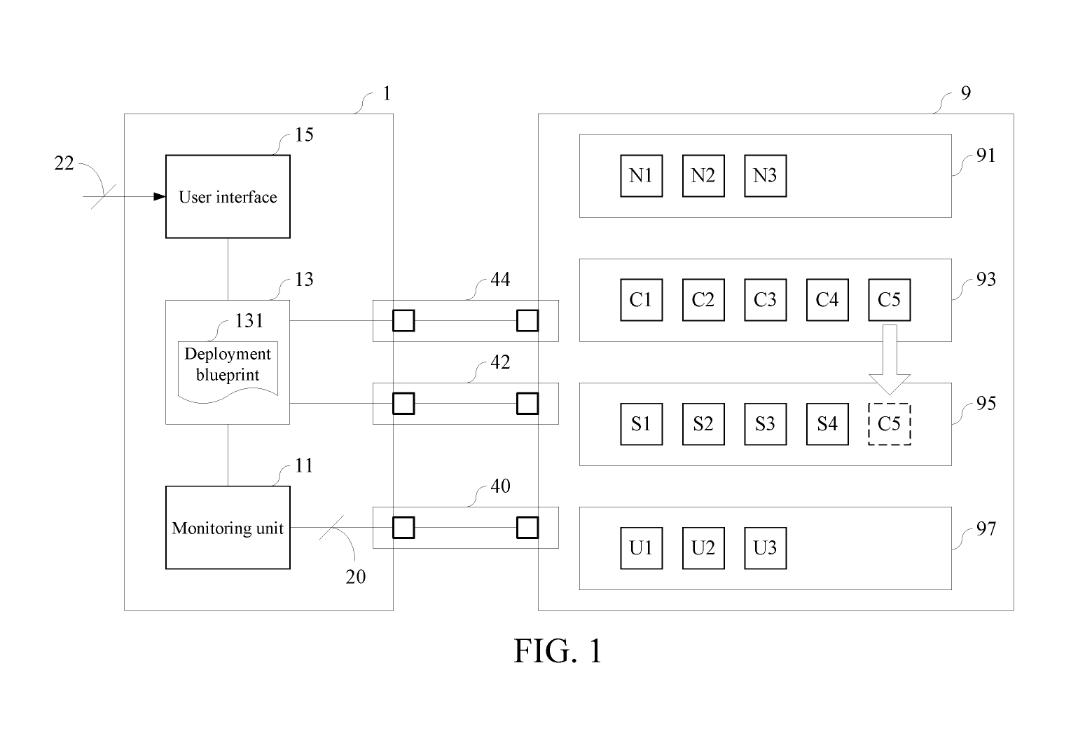

An embodiment (which is called “a first embodiment” hereinafter) of the present invention is a physical machine management device. FIG. 1 is a block diagram of an example of the physical machine management device. As shown in FIG. 1, the physical machine management device 1 may comprise a monitoring unit 11 and a deployment unit 13. The physical machine management device 1 may further comprise a user interface (UI) 15 (which is not an absolutely essential element). The monitoring unit 11, the deployment unit 13 and the UI 15 may be either directly or indirectly electrically connected to each other, and may transmit data therebetween. Herein, “directly electrically connected” means that the two components are electrically connected without any other intervening component therebetween, and “indirectly electrically connected” means that the two components are electrically connected with an intervening component therebetween.

The physical machine management device 1 may be any of various computer-related devices, for example but not limited to, a laptop computer, a tablet computer, a notebook computer or the like. A computer-related device may comprise a computing component such as a general-purpose processor or microprocessor, and execute various computations by use of this computing component. A computer-related device may comprise a storage component such as a general-purpose memory and/or storage, and store various data in this storage component. A computer-related device may comprise general-purpose input/output components, and receive incoming data and transmit outgoing data via the input/output components. A computer-related device may execute corresponding operations described below via the computing component, the storage component, the input/output components or the like according to processes implemented by software, firmware, programs, algorithms or the like.

As shown in FIG. 1, a hardware pool 9 may include a plurality of physical machines, i.e., the hardware pool 9 is one set of several physical machines. For example, the hardware pool 9 may be a set of all physical machines in a certain company. Each of the physical machines in the hardware pool 9 may correspond to a group according to the service that the physical machine provides. For example, physical machines N1, N2 and N3 in the hardware pool 9 may be deployed as network nodes to provide the network service, and thus belong to a network group 91. Physical machines C1, C2, C3, C4 and C5 in the hardware pool 9 may be deployed as computing nodes to provide the computing service, and thus belong to a computing group 93. Physical machines S1, S2, S3 and S4 in the hardware pool 9 may be deployed as storage nodes to provide the storage service, and thus belong to a storage group 95. Physical machines U1, U2 and U3 in the hardware pool 9 may be unused nodes (i.e., physical machines not providing any service currently), and thus belong to an unused group 97. The aforesaid types of the groups and the number of physical machines in each of the groups are only illustrated as examples rather than to limit the present invention.

The monitoring unit 11 may include a part or all of the computing component, the storage component, the input/output components or the like in a computer-related device, and may monitor information 20 of the hardware pool 9 according to processes implemented by software, firmware, programs, algorithms or the like in the computer-related device. The monitoring unit 11 may monitor the information 20 of the hardware pool 9 through an Application Programming Interface (API) 40. The API 40 may correspond to various protocols or interfaces that monitor the information of the physical machine based on networks, e.g., interfaces or protocols such as the Intelligent Platform Management Interface (IPMI) and/or the Simple Network Management Protocol (SNMP). In other words, the monitoring unit 11 may monitor the information 20 of the hardware pool 9 based on the IPMI and/or the SNMP. The IPMI can span different operation systems, firmware and hardware platforms, and can intelligently monitor, control and automatically report back the operation status of numerous servers to reduce the cost of server systems. The SNMP can support network management systems to monitor if any event that needs to be paid attention occurs in the devices connected to the network. Details of the IPMI and the SNMP are well known to those of ordinary skill in the art, and thus will not be further described herein.

In other embodiments, the monitoring unit 11 may specifically comprise a measuring tool and a measurement database (not shown). The measuring tool is configured to measure various information of all the physical machines in the hardware pool 9 (e.g., measure the hardware information and the service information of the physical machines based on the IPMI and/or the SNMP), and the measurement database may be configured to store the information. The monitoring unit 11 may monitor the information 20 of the hardware pool 9 through the measuring tool and the measurement database.

The deployment unit 13 may include a part or all of the computing component, the storage component, the input/output components or the like in a computer-related device, and may move a physical machine in the hardware pool 9 from a first group to a second group depending on a deployment blueprint 131 and the information 20 according to processes implemented by software, firmware, programs, algorithms or the like in the computer-related device, wherein the first group and the second group are of different types. For example, as shown in FIG. 1, if the hardware pool 9 is short of physical machines providing the storage service (i.e., the number of the physical machines in the storage group 95 is insufficient) and the deployment unit 13 determines from the information 20 that the physical machine C5 can be changed from providing the computing service into providing the storage service, then the deployment unit 13 can move the physical machine C5 from the computing group 93 to the storage group 95 according to deployment rules specified in the deployment blueprint 131. In this case, the computing group 93 is a first group (i.e., the original group), and the storage group 95 is a second group (i.e., the new group).

The deployment rules specified in the deployment blueprint 131 may include but are not limited to items such as Resource selection, Topology selection, and Policy selection or the like. In this case, the deployment unit 13 may select items such as the resource, the topology and the policy according to the deployment rules specified in the deployment blueprint 131 so that which physical machine in the hardware pool 9 can be moved and to which new group the physical machine can be moved can be determined. The deployment blueprint 131 may be stored into the physical machine management device 1 in various forms for use by the deployment unit 13.

The various deployment rules specified in the deployment blueprint 131 (e.g., the aforesaid Resource selection, Topology selection, and Policy selection) may include various parameters for use by the deployment unit 13 to determine which physical machine in the hardware pool 9 can be moved and to which new group the physical machine can be moved. Such parameters may for example be but are not limited to: the temperature status, the availability of the Central Processing Unit (CPU), the fan speed, the voltage status, the utilization ratio of the memory, the bandwidth of the network, the utilization ratio of the CPU, the utilization ratio of the storage, the traffic volume of the network, the information of the network interface card, the pause time of the service, the designated service status, the input/output, the overall threshold of the CPU, the overall threshold of the utilization ratio of the memory or the like. For example, if the utilization ratio of the CPU required by a service group providing a service is higher than the overall threshold of the CPU, and the utilization ratio of the memory required is higher than the overall threshold of the utilization ratio of the memory, then the deployment unit 13 may determine that the service group must be augmented with additional physical machines. As another example, if the actual utilization ratio of the CPU of a physical machine providing a service is lower than the target utilization ratio of the CPU, and the actual utilization ratio of the memory of the physical machine is lower than the target utilization ratio of the memory, then the deployment unit 13 may determine that the physical machine has to be changed into providing other services instead.

The memory and the storage may be directly quantified, so the utilization ratios of the memory and the storage can be compared directly. However, because different CPUs may differ in clock pulses, a same work may result in different utilization ratios when being executed on different CPUs. Therefore, the deployment unit 13 may quantify the utilization ratio of the CPU in the following way so as to predict the utilization ratio of the CPU of a physical machine after a work has migrated to the physical machine. In particular, the deployment unit 13 may define the utilization ratio of the CPU to be the ratio obtained though dividing the sum of the used resource and the required resource of the CPU by the overall resource of the CPU. For example, if the overall resource of the CPU of a physical machine is qualified as 1200 (e.g., the product of Clock Pulse 3 GHz, Core Number 4, and Usage Ratio 100%), the used resource of the CPU is qualified as 120 (e.g., the product of Clock pulse 3 GHz, Core Number 2, and Usage Ratio 20%), and the required source is qualified as 120 (e.g., the product of Clock pulse 3 GHz, Core Number 2, and Usage Ratio 20%), then the deployment unit 13 can predict that the utilization ratio of the CPU of the physical machine is 20% (i.e., (120+120)/1200).

The UI 15 may include a part or all of the computing component, the storage component, the input/output components or the like in a computer-related device, and may receive a user input 22 according to processes implemented by software, firmware, programs, algorithms or the like in the computer-related device. In the case that the deployment blueprint 131 is not stored in the physical machine management device 1 (e.g., at the initial stage), the deployment unit 13 may create a deployment blueprint 131 according to the user input 22. In the case that the deployment blueprint 131 is already stored in the physical machine management device 1 (e.g., at the operating stage), the deployment unit 13 may update the current deployment blueprint 131 according to the user input 22.

In the hardware pool 9, in principle, each physical machine is installed with an operation system corresponding to the group to which the physical machine belongs. The operation system installed on each physical machine corresponds to the corresponding service that the physical machine can currently provide. For example, as shown in FIG. 1, the operation systems installed on the physical machines N1-N3 are provided for the physical machines N1-N3 to provide the network service; the operation systems installed on the physical machines C1-C5 are provided for the physical machines C1-C5 to provide the computing service; and the operation systems installed on the physical machines S1-S4 are provided for the physical machines S1-S4 to provide the storage service. The operation systems installed on the physical machines U1-U3 are provided for the physical machines U1-U3 to remain in the status of providing no service. In other embodiments, no operation system may be installed on the physical machines U1-U3.

During the process of moving any physical machine in the hardware pool 9 from a first group (i.e., the original group) to a second group (i.e., the new group) by the deployment unit 13, the deployment unit 13 instructs the current work of the physical machine to migrate to another physical machine or other physical machines in the first group, then removes the originally installed operation system (i.e., a first operation system) from the physical machine, and next installs an operation system corresponding to the second group (i.e., a second operation system) into the physical machine. For example, as shown in FIG. 1, if the deployment unit 13 determines that the physical machine C5 can be changed from providing the computing service into providing the storage service according to the information 20, then the deployment unit 13 first instructs the current work of the physical machine C5 to migrate to other physical machines in the computing group 93 (i.e., one or more of the physical machines C1-C4), then removes the originally installed operation system from the physical machine C5, and next installs an operation system corresponding to the storage group 95 into the physical machine C5. Thereby, the physical machine C5 is moved from the computing group 93 to the storage group 95.

The deployment unit 13 may instruct the hardware pool 9 to perform various settings or actions via an API 42. The API 42 may correspond to various secure transmission protocols that are based on networks, e.g., the Secure Shell (SSH). The SSH is a secure protocol that is established on the basis of the application layer and the transport layer, and provides secure transport and use environments for the Shell on a computer. Details of the SSH are well known by those of ordinary skill in the art, and thus will not be further described herein. Therefore, during the process of moving any physical machine in the hardware pool 9 from the original group to the new group by the deployment unit 13, the deployment unit 13 may first instruct the current work of the physical machine to migrate to another physical machine or other physical machines in the original group based on a secure transmission protocol, and remove the originally installed operation system from the physical machine according to the secure transmission protocol.

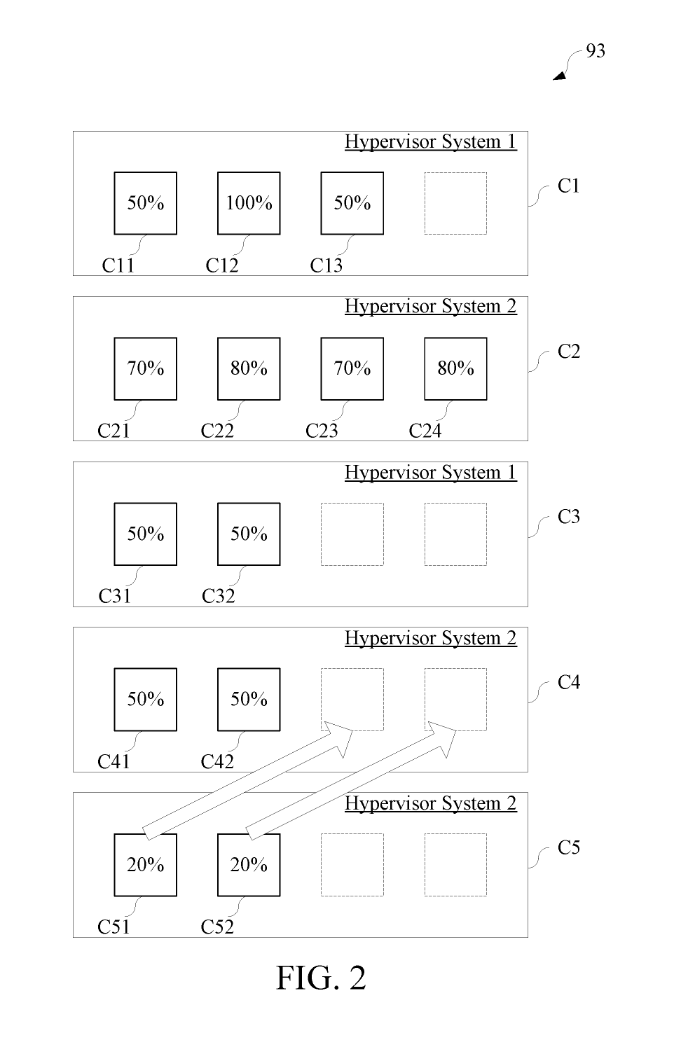

FIG. 2 is a schematic view illustrating an exemplary example of how the deployment unit 13 instructs the current work of a physical machine to migrate according to one or more embodiments of the present invention. As shown in FIG. 2, it is assumed that the computing group 93 comprises a total of five physical machines (i.e., the physical machines C1, C2, C3, C4 and C5), wherein the physical machines C1 and C3 belong to a same Hypervisor system, and the physical machines C2, C4 and C5 belong to another Hypervisor system. The Hypervisor system refers to a system that is installed on a physical machine to provide a virtual machine service, and may be but is not limited to: vCenter developed by the VMware, CAKE developed by the Institute for Information Industry, Hyper-V developed by the Microsoft, XenServer developed by Citrix or the like. It is assumed that each of the physical machines C1-C5 is capable of being provided with four virtual machines, but the physical machine C1 is currently provided with a total of three virtual machines (i.e., virtual machines C11, C12 and C13), the physical machine C2 is currently provided with a total of four virtual machines (i.e., virtual machines C21, C22, C23 and C24), the physical machine C3 is currently provided with a total of two virtual machines (i.e., virtual machines C31 and C32), the physical machine C4 is currently provided with a total of two virtual machines (i.e., virtual machines C41 and C42), and the physical machine C5 is currently provided with a total of two virtual machines (i.e., virtual machines C51 and C52).

As shown in FIG. 2, it is assumed that the utilization ratios of the CPUs of the virtual machines C11, C12 and C13 are respectively 50%, 100% and 50% (the average utilization ratio of the CPUs is 200/400=50%), the utilization ratios of the CPUs of the virtual machines C21, C22, C23 and C24 are respectively 70%, 80%, 70% and 80% (the average utilization ratio of the CPUs is 300/400=75%), the utilization ratios of the CPUs of the virtual machines C31 and C32 are respectively 50% and 50% (the average utilization ratio of the CPUs is 100/400=25%), the utilization ratios of the CPUs of the virtual machines C41 and C42 are respectively 50% and 50% (the average utilization ratio of the CPUs is 100/400=25%), and the utilization ratios of the CPUs of the virtual machines C51 and C52 are respectively 20% and 20% (the average utilization ratio of the CPUs is 40/400=10%).

Taking FIG. 2 as an example, if it is further assumed that the deployment unit 13 determines that the physical machine C5 can be changed from providing the computing service into providing the storage service according to the information 20, then the deployment unit 13 first instructs the current work of the physical machine C5 to migrate to other physical machines in the computing group 93 (i.e., one or more of the physical machines C1-C4). Additionally, it is assumed that the rules specified in the deployment blueprint 131 are that: the priority of the manager of the physical machine is higher than the priority of the utilization ratio of the physical machine; and the utilization ratio of the physical machine is the average utilization ratio of the CPU, and the physical machine with a lower average utilization ratio of the CPU has a higher priority. In this case, as shown in FIG. 2, because the physical machines C1 and C3 and the physical machine C5 belong to different managers and the physical machines C2 and C4 and the physical machine C5 belong to a same manager, the deployment unit 13 will preferentially choose the physical machines C2 and C4. Because the average utilization ratio of the CPU of the physical machine C2 is higher than the average utilization ratio of the CPU of the physical machine C4, the deployment unit 13 will preferentially choose the physical machine C4. Thus, preferably, the deployment unit 13 may instruct the current work of the physical machine C5 to migrate to the physical machine C4. The deployment unit 13 may instruct the current work of the physical machine C5 (i.e., the work operated on the virtual machines C51 and C52) to migrate to the virtual machines C41 and C42 that have been created on the physical machine C4. Alternatively, the deployment unit 13 may provide additional virtual machines C51 and C52 on the physical machine C4, and then instruct the current work of the physical machine C5 to migrate to the virtual machines C51 and C52 on the physical machine C4. Optionally, the deployment unit 13 may also instruct the current work of the physical machine C5 to migrate to several of the physical machines C1-C4.

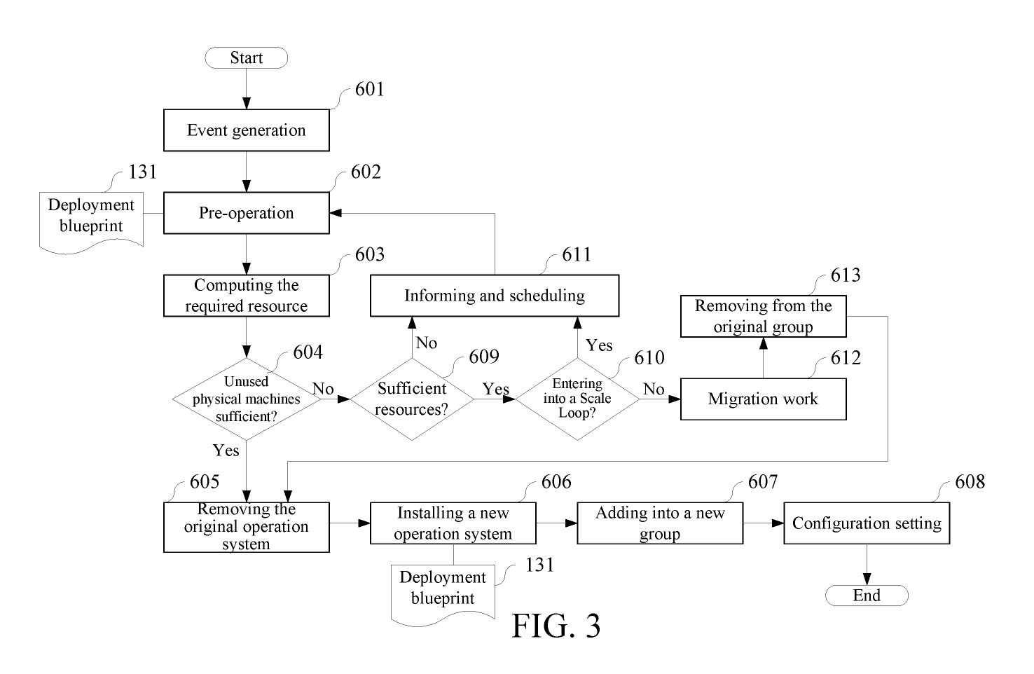

Hereinafter, FIG. 3 will be taken as example to describe the overall operation of the physical machine management device 1, but this is not for purpose of limitation. FIG. 3 is a schematic view illustrating an exemplary example of the overall operation of the physical machine management device 1. As described in FIG. 3, various events may be generated according to the information 20 provided by the monitoring unit 11 (labeled as 601). For ease of description, an event that the physical machine management device 1 is short of physical machines providing the storage service is taken as an example for description.

When an event that the number of physical machines providing the storage service is insufficient occurs, the physical machine management device 1 may perform various pre-operations according to the current deployment blueprint 131 (labeled as 602). The pre-operations may include but are not limited to: reading the various deployment rules specified in the deployment blueprint 131 (e.g., items such as the Resource selection, the Topology selection, and the Strategy selection) and establishing an appropriate operation environment accordingly by the deployment unit 13. Next, the physical machine management device 1 may compute the resource required by the event (labeled as 603).

In response to the resource required by the event, the physical machine management device 1 may first determine whether there is a sufficient number of unused physical machines (labeled as 604), e.g., the physical machines U1-U3 as shown in FIG. 1. If there is a sufficient number of unused physical machines, then the physical machine management device 1 may preferentially deploy one or more unused physical machines as storage nodes to provide the required storage service. More particularly, If there is a sufficient number of unused physical machines, then the physical machine management device 1 may remove the original operation system from the one or more unused physical machines (labeled as 605), and then reinstall an operation system capable of providing the storage service to the one or more unused physical machines (labeled as 606). Next, the physical machine management device 1 may add the one or more unused physical machines into a storage group (labeled as 607), e.g., the storage group 95 as shown in FIG. 1. Finally, the physical machine management device 1 may perform various configuration settings on the one or more unused physical machines added into the storage group (labeled as 608) so that the one or more unused physical machines provide the corresponding storage service.

On the other hand, if the number of unused physical machines is insufficient, then the physical machine management device 1 may determine whether the physical machine not providing the storage service (e.g., the physical machines N1-N3 and C1-C5 shown in FIG. 1) have sufficient resources to provide the required storage service (labeled as 609). If the determination result is “Yes”, then the physical machine management device 1 may further determine whether the process will enter into a Scale Loop (labeled as 610). The determination made for the Scale Loop (labeled as 610) is to avoid the following condition: although the physical machine not providing the storage service has sufficient resources to provide the required storage service, the number of the physical machines providing other services may become insufficient when the physical machine not providing the storage service is changed into providing the required storage service instead. In the case that the physical machine not providing the storage service do not have sufficient resources or the process will enter into the Scale Loop, the physical machine management device 1 may inform the deployment manager of the relevant information and wait for the next deployment scheduling (labeled as 611) so as to enter into the pre-operations again (labeled as 602).

If the process will not enter into the Scale Loop, then the physical machine management device 1 may instruct the current work operated on the physical machine not providing the storage service to migrate to other physical machines (labeled as 612). Thereafter, the physical machine management device 1 may remove the physical machine not providing the storage service from the original group (labeled as 613). As shown in FIG. 1, the physical machine C5 may be removed from the computing group 93. Next, the physical machine management device 1 may remove the originally installed operation system from the physical machine not providing the storage service (labeled as 605), and sequentially perform operations of installing a new operation system, adding into a new group, performing configuration settings or the like (labeled as 606-608).

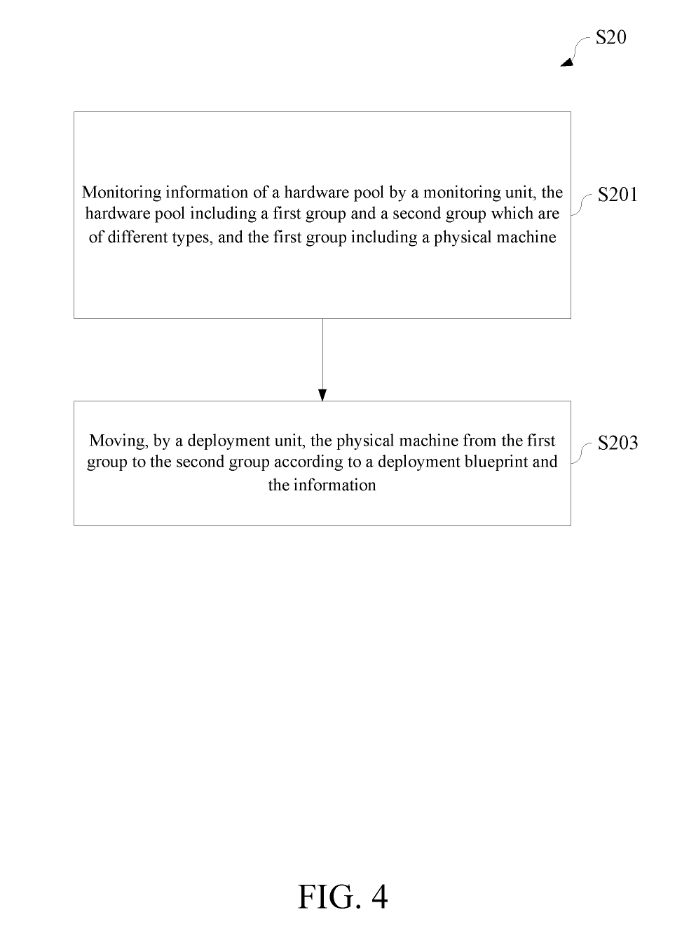

Another embodiment (which is called “a second embodiment” hereinafter) of the present invention is a physical machine management method. FIG. 4 is a flowchart diagram illustrating an exemplary example of a physical machine management method according to one or more embodiments of the present invention. The order in which all steps provided for the second embodiment and various examples thereof is presented may be adjusted arbitrarily without departing from the spirit of the present invention, and shall not be considered as limiting.

As shown in FIG. 4, the physical machine management method S20 may comprise the following steps of: monitoring information of a hardware pool by a monitoring unit, the hardware pool including a first group and a second group which are of different types, and the first group including a physical machine (step S201); and moving, by a deployment unit, the physical machine from the first group to the second group according to a deployment blueprint and the information (step S203). The physical machine management method S20 may substantially be implemented on the physical machine management device 1 of the first embodiment. Thus, the monitoring unit and the deployment unit shown in FIG. 4 may substantially correspond to the monitoring unit 11 and the deployment unit 13 included in the physical machine management device 1.

As an exemplary example of the second embodiment, the physical machine management method S20 may further comprise the following steps of: receiving a user input by a user interface (UI); and establishing or updating the deployment blueprint according to the user input by the deployment unit. The UI may substantially correspond to the UI 15 included in the physical machine management device 1.

As an exemplary example of the second embodiment, the step S201 may further comprise the following step of: monitoring, by the monitoring unit, the information of the hardware pool based on the intelligent platform management interface (IPMI) and the simple network management protocol (SNMP).

As an exemplary example of the second embodiment, the physical machine may be installed with a first operation system corresponding to the first group, and the step S203 may further comprise the following steps of: instructing the current work of the physical machine to migrate to another physical machine in the first group by the deployment unit; removing the first operation system from the physical machine by the deployment unit; and installing a second operation system corresponding to the second group into the physical machine by the deployment unit.

As an exemplary example of the second embodiment, the physical machine may be installed with a first operation system corresponding to the first group, and the step S203 may further comprise the following steps of: instructing the current work of the physical machine to migrate to another physical machine in the first group by the deployment unit; removing the first operation system from the physical machine by the deployment unit; and installing a second operation system corresponding to the second group into the physical machine by the deployment unit. Additionally, the step of the migration of the current work further comprises the following step of: instructing, by the deployment unit, the current work of the physical machine to migrate to the another physical machine in the first group based on a secure transmission protocol; and the step of removing the first operation system further comprises the following step of: removing, by the deployment unit, the first operation system from the physical machine based on the secure transmission protocol.

As an exemplary example of the second embodiment, the physical machine may be installed with a first operation system corresponding to the first group, and the step S203 may further comprise the following steps of: instructing the current work of the physical machine to migrate to another physical machine in the first group by the deployment unit; removing the first operation system from the physical machine by the deployment unit; and installing a second operation system corresponding to the second group into the physical machine by the deployment unit. Additionally, the step of updating the operation system further comprises the following step of: installing, by the deployment unit, the second operation system into the physical machine based on Pre-Boot Execution Environment (PXE).

The physical machine management method S20 substantially comprises steps corresponding to all operations of the physical machine management method 1. Since those of ordinary skill in the art can directly know all the corresponding steps comprised in the physical machine management method S20 according to the above description of the physical machine management device 1, these corresponding steps will not be further described herein.

According to the above descriptions, the present invention can obtain various pieces of information of all physical machines by monitoring all the physical machines, and knows therefrom the status of all the physical machines (e.g., the available resources and the operating efficiency, etc.). Additionally, the present invention can change to which group the physical machine belongs (i.e., change the service that the physical machine previously provides) according to a deployment blueprint and the information. Therefore, under the circumstance that the number of physical machines providing a certain service is insufficient, the present invention may additionally determine whether one or more physical machines not providing the service have the capability to provide the service instead. If the determination result is “Yes”, then the present invention may further change the one or more physical machines not providing the service into physical machines providing the service. As compared to the conventional processing method, the present invention can effectively reduce the possibility of additionally providing physical machines and correspondingly reduce the time of deploying these physical machines.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A physical machine management device, comprising:
a monitoring unit, being configured to monitor information of a hardware pool, the hardware pool including a first group and a second group which are of different types, and the first group including a physical machine; and
a deployment unit electrically connected to the monitoring unit, being configured to move the physical machine from the first group to the second group according to a deployment blueprint and the information.

2. The physical machine management device of claim 1, further comprising a user interface (UI), wherein the UI is electrically connected to the monitoring unit and is configured to receive a user input, and the deployment unit establishes or updates the deployment blueprint according to the user input.

3. The physical machine management device of claim 1, wherein the monitoring unit monitors the information of the hardware pool based on the intelligent platform management interface (IPMI) and the simple network management protocol (SNMP).

4. The physical machine management device of claim 1, wherein the physical machine is installed with a first operation system corresponding to the first group, and during the process of moving the physical machine from the first group to the second group by the deployment unit, the deployment unit instructs the current work of the physical machine to migrate to another physical machine in the first group, removes the first operation system from the physical machine, and installs a second operation system corresponding to the second group into the physical machine.

5. The physical machine management device of claim 4, wherein the deployment unit instructs the current work of the physical machine to migrate to the another physical machine in the first group and remove the first operation system from the physical machine based on a secure transmission protocol.

6. The physical machine management device of claim 4, wherein the deployment unit installs the second operation system into the physical machine based on Pre-Boot Execution Environment.

7. A physical machine management method, comprising:
monitoring information of a hardware pool by a monitoring unit, the hardware pool including a first group and a second group which are of different types, and the first group including a physical machine; and
moving, by a deployment unit, the physical machine from the first group to the second group according to a deployment blueprint and the information.

8. The physical machine management method of claim 7, further comprising:
receiving a user input by a user interface (UI); and
establishing or updating the deployment blueprint according to the user input by the deployment unit.

9. The physical machine management method of claim 7, wherein the step of monitoring the information further comprises:
monitoring, by the monitoring unit, the information of the hardware pool based on the intelligent platform management interface (IPMI) and the simple network management protocol (SNMP).

10. The physical machine management method of claim 7, wherein the physical machine is installed with a first operation system corresponding to the first group, and the step of moving the physical machine further comprises:
instructing the current work of the physical machine to migrate to another physical machine in the first group by the deployment unit;
removing the first operation system from the physical machine by the deployment unit; and
installing a second operation system corresponding to the second group into the physical machine by the deployment unit.

11. The physical machine management method of claim 10, wherein
the step of the migration of the current work further comprises:
instructing, by the deployment unit, the current work of the physical machine to migrate to the another physical machine in the first group based on a secure transmission protocol; and
the step of removing the first operation system further comprises:
removing, by the deployment unit, the first operation system from the physical machine based on the secure transmission protocol.

12. The physical machine management method of claim 10, wherein the step of updating the operation system further comprises:
installing, by the deployment unit, the second operation system into the physical machine based on Pre-Boot Execution Environment.
